(19) United States
(12) Patent Application Publication
(10) Pub. No.: US 2016/0311509 A1
(43) Pub. Date: Oct. 27, 2016

(54) VESSEL CARGO MONITORING SYSTEM

(71) Applicant: Joel Buffa, Huntington Beach, CA (US)

(72) Inventor: Joel Buffa, Huntington Beach, CA (US)

(21) Appl. No.: 14/696,682

(22) Filed: Apr. 27, 2015

(51) Int. Cl. B63B 39/12; G06K 7/10; B63B 39/14

(52) U.S. Cl. CPC B63B 39/12; B63B 39/14; G06K 7/10366; B63B 2201/16; B63B 2213/02

(57) ABSTRACT

A system for assessing vessel stability includes a weight sensor, a data storage device, a locator, and a display device. The system provides real-time weight and position data for each cargo aboard the vessel in relation to the vessel's cargo areas. The display device may be used by the vessel Captain to assess the stability of the vessel, for instance, during loading and unloading of cargoes when the vessel is near a rig. The weight and position data may alternatively be sent to the vessel stability computer system to assist in determining the vessel stability.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to cargo monitoring aboard a vessel utilizing identification, weight, and positioning data. In particular, the present invention relates to a system and method for assessing vessel stability by monitoring the weight and position of the cargoes aboard the vessel and displaying the weight distribution of the cargoes relative to the cargo area of the vessel. In an alternative embodiment, the system could interact with the vessel stability computer system to assist in calculating the vessel stability.

### BACKGROUND

The present invention seeks to provide a system for ascertaining vessel stability. The system uses existing technologies such as RFID and RTLS to provide precise weight distribution of the cargoes aboard the vessel cargo areas. The information can be used to provide the vessel operator visual display of the spatial coordinates of the cargoes relative to the cargo area in addition to their weights. The information can also be linked to the vessel stability computer system to assist in calculating the vessel stability.

Currently when a cargo lift is placed onboard a vessel the crane operator lifts the cargo by a sling and a load cell from the crane provides the weight of the cargo to the crane operator. The weight of the cargo is recorded and after all the different cargoes are placed onboard the vessel, a Shipping Manifest is provided to the Captain of the vessel. The Captain has to then look on the back deck for where each piece of cargo is and estimate how much weight is in different portions of the back deck. He then summarizes the estimated location and weight of various cargos into a stability program.

The purpose of the invention is to provide a far more precise location of the cargo to a stability program and reduce human involvement in the calculation of the weight of cargo on a cargo area, such as the back deck of the vessel or below deck cargo area. Vessels transport cargo everyday and one type of vessel is a supply vessel. These vessels transport cargo to oil rigs and drill ships from land. The cargo transported is not limited to cargo just on deck. It may also include fuel, liquid mud, barite, cement, potable water, etc. below deck. This cargo puts stress on the steel of the vessel and there is possibility that a ship officer can overload the vessel and cause stress on the steel. This could result in the ship sinking.

These supply boats can be on standby at an offshore rig for days or weeks and be used as storage for cargo if the rig or drillship does not have extra storage space. It is common to go from standby (200-500 meters off the rig) to alongside the rig multiple times to offload or backload cargo. The vessel at the rig may have a large amount of deck cargo area but the personnel at the rig may request to transfer the cargoes to a below deck cargo area. The Captain would reference the stability program to ascertain if he would be able to load that on the below deck cargo area or not. Errors associated with the Captain's estimates of the location of the cargoes cause miscalculation in vessel stability.

Radio-frequency identification (RFID) is the wireless use of electromagnetic fields to transfer data, for the purposes of automatically identifying and tracking tags attached to objects. The tags contain electronically stored information. Some tags are powered by electromagnetic induction from magnetic fields produced near the reader. Some types collect energy from the interrogating radio waves and act as a passive transponder. Other types have a local power source such as a battery and may operate at hundreds of meters from the reader. Unlike a barcode, the tag does not necessarily need to be within line of sight of the reader and may be embedded in the tracked object. RFID is one method for Automatic Identification and Data Capture (AIDC).

RFID tags are used in many industries. For example, an RFID tag attached to an automobile during production can be used to track its progress through the assembly line; RFID-tagged pharmaceuticals can be tracked through warehouses; and implanting RFID microchips in livestock and pets allows positive identification of animals.

A radio-frequency identification system uses tags, or labels attached to the objects to be identified. Two-way radio transmitter-receivers called interrogators or readers send a signal to the tag and read its response.

RFID tags can be either passive, active, or battery-assisted passive. An active tag has an on-board battery and periodically transmits its ID signal. A battery-assisted passive (BAP) has a small battery on board and is activated when in the presence of an RFID reader. A passive tag is cheaper and smaller because it has no battery; instead, the tag uses the radio energy transmitted by the reader. However, to operate a passive tag, it must be illuminated with a power level roughly a thousand times stronger than for signal transmission. That makes a difference in interference and in exposure to radiation.

Tags may either be read-only, having a factory-assigned serial number that is used as a key into a database, or may be read/write, where object-specific data can be written into the tag by the system user. Field programmable tags may be write-once, read-multiple; “blank” tags may be written with an electronic product code by the user.

RFID tags contain at least two parts: an integrated circuit for storing and processing information, modulating and demodulating a radio-frequency (RF) signal, collecting DC power from the incident reader signal, and other specialized functions; and an antenna for receiving and transmitting the signal. The tag information is stored in a non-volatile memory. The RFID tag includes either fixed or programmable logic for processing the transmission and sensor data, respectively.

An RFID reader transmits an encoded radio signal to interrogate the tag. The RFID tag receives the message and then responds with its identification and other information. This may be only a unique tag serial number, or may be product-related information such as a stock number, lot or batch number, production date, or other specific information. Since tags have individual serial numbers, the RFID system design can discriminate among several tags that might be within the range of the RFID reader and read them simultaneously.

RFID systems can be classified by the type of tag and reader. A Passive Reader Active Tag (PRAT) system has a passive reader which only receives radio signals from active tags (battery operated, transmit only). The reception range of a PRAT system reader can be adjusted from 1-2,000 feet (0-600 m) allowing flexibility in applications such as asset protection and supervision. An Active Reader Passive Tag (ARPT) system has an active reader, which transmits interrogator signals and also receives authentication replies from passive tags. An Active Reader Active Tag (ARAT) system uses active tags awoken with an interrogator signal from the active reader. A variation of this system could also use a Battery-Assisted Passive (BAP) tag which acts like a passive tag but has a small battery to power the tag's return reporting signal.

Fixed readers are set up to create a specific interrogation zone which can be tightly controlled. This allows a highly defined reading area for when tags go in and out of the interrogation zone. Mobile readers may be hand-held or mounted on carts or vehicles. Signal Frequencies range from 120 KHZ to 10 GHZ.

Signaling between the reader and the tag is done in several different incompatible ways, depending on the frequency band used by the tag. Tags operating on LF and HF bands are, in terms of radio wavelength, very close to the reader antenna because they are only a small percentage of a wavelength away. In this near field region, the tag is closely coupled electrically with the transmitter in the reader. The tag can modulate the field produced by the reader by changing the electrical loading the tag represents. By switching between lower and higher relative loads, the tag produces a change that the reader can detect. At UHF and higher frequencies, the tag is more than one radio wavelength away from the reader, requiring a different approach. The tag can backscatter a signal. Active tags may contain functionally separated transmitters and receivers, and the tag need not respond on a frequency related to the reader's interrogation signal.

An Electronic Product Code (EPC) is one common type of data stored in a tag. When written into the tag by an RFID printer, the tag contains a 96-bit string of data. The first eight bits are a header which identifies the version of the protocol. The next 28 bits identify the organization that manages the data for this tag; the organization number is assigned by the EPCGlobal consortium. The next 24 bits are an object class, identifying the kind of product; the last 36 bits are a unique serial number for a particular tag. These last two fields are set by the organization that issued the tag. Rather like a URL, the total electronic product code number can be used as a key into a global database to uniquely identify a particular product.

Often more than one tag will respond to a tag reader, for example, many individual products with tags may be shipped in a common box or on a common pallet. Collision detection is important to allow reading of data. Two different types of protocols are used to “singulate” a particular tag, allowing its data to be read in the midst of many similar tags. In a slotted Aloha system, the reader broadcasts an initialization command and a parameter that the tags individually use to pseudo-randomly delay their responses. When using an “adaptive binary tree” protocol, the reader sends an initialization symbol and then transmits one bit of ID data at a time; only tags with matching bits respond, and eventually only one tag matches the complete ID string.

Real-time locating systems (RTLS) are used to automatically identify and track the location of objects or people in real time, usually within a building or other contained area. Wireless RTLS tags are attached to objects or worn by people, and in most RTLS, fixed reference points receive wireless signals from tags to determine their location. Examples of real-time locating systems include tracking automobiles through an assembly line, locating pallets of merchandise in a warehouse, or finding medical equipment in a hospital. The physical layer of RTLS technology is usually some form of radio frequency (RF) communication, but some systems use optical (usually infrared) or acoustic (usually ultrasound) technology instead of or in addition to RF. Tags and fixed reference points can be transmitters, receivers, or both, resulting in numerous possible technology combinations.

RTLS are a form of local positioning system, and do not usually refer to GPS, mobile phone tracking. Location information usually does not include speed, direction, or spatial orientation. RTLS are generally used in indoor and/or confined areas, such as buildings, and do not provide global coverage like GPS. RTLS tags are affixed to mobile items to be tracked or managed. RTLS reference points, which can be either transmitters or receivers, are spaced throughout a building (or similar area of interest) to provide the desired tag coverage. In most cases, the more RTLS reference points that are installed, the better the location accuracy, until the technology limitations are reached.

A number of disparate system designs are all referred to as “real-time locating systems”, but there are two primary system design elements. The simplest form of choke point locating is where short range ID signals from a moving tag are received by a single fixed reader in a sensory network, thus indicating the location coincidence of reader and tag. Alternately, a choke point identifier can be received by the moving tag, and then relayed, usually via a second wireless channel, to a location processor. Accuracy is usually defined by the sphere spanned with the reach of the choke point transmitter or receiver. The use of directional antennas, or technologies such as infrared or ultrasound that are blocked by room partitions, can support choke points of various geometries. Locating in relative coordinates requires ID signals from a tag received by a multiplicity of readers in a sensory network, and a position is estimated using one or more locating algorithms, such as trilateration, multilateration, or triangulation. Equivalently, ID signals from several RTLS reference points can be received by a tag, and relayed back to a location processor. Localization with multiple reference points requires that distances between reference points in the sensory network be known in order to precisely locate a tag, and the determination of distances is called ranging. Another way to calculate relative location is if mobile tags communicate directly with each other, then relay this information to a location processor.

RF trilateration uses estimated ranges from multiple receivers to estimate the location of a tag. RF triangulation uses the angles at which the RF signals arrive at multiple receivers to estimate the location of a tag. Many obstructions, such as walls or furniture, can distort the estimated range and angle readings leading to varied qualities of location estimate. Estimation-based locating is often measured in accuracy for a given distance, such as 90% accurate for 10 meter range. Systems that use locating technologies that do not go through walls, such as infrared or ultrasound, tend to be more accurate in an indoor environment because only tags and receivers that have line of sight (or near line of sight) can communicate.

A load cell is a transducer that is used to create an electrical signal whose magnitude is directly proportional to the force being measured. The various types of load cells include hydraulic load cells, pneumatic load cells and strain gauge load cells.

### SUMMARY

In one aspect, a system for assessing vessel stability is disclosed wherein the vessel comprises a cargo area operative to receive a plurality of cargoes and wherein the system comprises a first sensor operative to determine a weight of a cargo, a data storage device, coupled with the cargo, responsive to the first sensor and operative to store the weight of the cargo, a locator, coupled with the vessel, operative to retrieve an identity data of the data storage device and the stored weight of the cargo from the data storage device, and to determine a position of the cargo relative to the cargo area, and a display device coupled with the locator and operative to display the cargo area, the weight, and position of the cargo relative to the cargo area.

Preferably, the first sensor is a load cell. Preferably, the data storage device is an RFID tag. Preferably, the locator comprises at least one of an RFID reader, a transmitter, a receiver, and a GPS system. Preferably, the display device comprises a user interface operative to display the cargo area, the weight, and position of the cargo relative to the cargo area. Preferably, the display device is a PDA. Preferably, the vessel is a cargo vessel.

Preferably, the vessel further comprises a vessel stability computer system coupled with the locator and operative to receive the weight and position of the cargo relative to the cargo area to assist in determining the vessel stability.

In another aspect, a system for assessing vessel stability is disclosed wherein the vessel comprises a cargo area operative to receive a plurality of cargoes and wherein the system comprises a first sensor operative to determine a weight of a cargo, a real-time locating system (RTLS), coupled with the vessel, said RTLS comprises an RFID tag, coupled with the cargo, said RFID tag is responsive to the first sensor and operative to store the weight of the cargo, wherein said RTLS is configured to retrieve an identity data and the stored weight of the cargo from of the RFID tag, to determine a position of the cargo relative to the cargo area, and to display the cargo area, the weight, and position of the cargo relative to the cargo area.

Preferably, the vessel further comprises a vessel stability computer system coupled with the RTLS and operative to receive the weight and position of the cargo relative to the cargo area to assist in determining the vessel stability.

In another aspect, a method for assessing vessel stability is disclosed wherein the vessel comprises a cargo area operative to receive a plurality of cargoes and wherein the method comprises determining a weight of a cargo, via a first sensor, storing the weight of the cargo, via a data storage device coupled with the cargo; retrieving an identity data of the data storage device and the stored weight of the cargo from the data storage device, via a locator coupled with the vessel, determining a position of the cargo relative to the cargo area, via the locator, and displaying the cargo area, the weight, and position of the cargo relative to the cargo area, via a display device coupled with the locator.

Preferably, the method further comprises receiving the weight and position of the cargo relative to the cargo area, via a vessel stability computer system coupled with the locator, to assist in determining the vessel stability.

Preferably, a method for providing a user interface for assessing vessel stability, wherein the user interface is accessible via the display device, comprises determining a weight of a cargo, via a first sensor, storing the weight of the cargo, via a data storage device coupled with the cargo, retrieving an identity data of the data storage device and the stored weight of the cargo from the data storage device, via a locator coupled with the vessel, determining a position of the cargo relative to the cargo area, via the locator, and displaying the cargo area, the weight, and position of the cargo relative to the cargo area, via a display device coupled with the locator.

Preferably, a non-transitory machine-readable storage medium provides instructions that, when executed by a processing system, causes the processing system to perform vessel stability assessment operations by providing a user interface for assessing vessel stability, wherein the user interface is accessible via the display device, comprises determining a weight of a cargo, via a first sensor, storing the weight of the cargo, via a data storage device coupled with the cargo; retrieving an identity data of the data storage device and the stored weight of the cargo from the data storage device, via a locator coupled with the vessel, determining a position of the cargo relative to the cargo area, via the locator, and displaying the cargo area, the weight, and position of the cargo relative to the cargo area, via a display device coupled with the locator.

Preferably, the method is performed wherein the first sensor is a load cell. Preferably, the method is performed wherein the data storage device is an RFID tag. Preferably, the method is performed wherein the locator comprises at least one of an RFID reader, a transmitter, a receiver, and a GPS system. Preferably, the method is performed wherein the display device is a PDA. Preferably, the method is performed wherein the vessel is a cargo vessel. Preferably, the method is performed wherein the steps of storing the weight of the cargo, retrieving an identity data of the data storage device and the stored weight of the cargo from the data storage device, and displaying the cargo area, the weight, and position of the cargo relative to the cargo area are performed via a real-time locating system (RTLS).

### DESCRIPTION OF THE DRAWINGS

FIG. 1 shows a preferred embodiment of a system for assessing vessel stability according to the present invention.

FIG. 1A shows a preferred embodiment of displaying the weight distribution of the cargo on the vessel of the system shown in FIG. 1.

FIG. 1B shows a preferred embodiment of displaying the weight distribution of the cargo on the vessel of the system shown in FIG. 1.

FIG. 2 shows a preferred method of assessing vessel stability according to the present invention.

### DETAILED DESCRIPTION OF THE PRESENTLY PREFERRED EMBODIMENTS

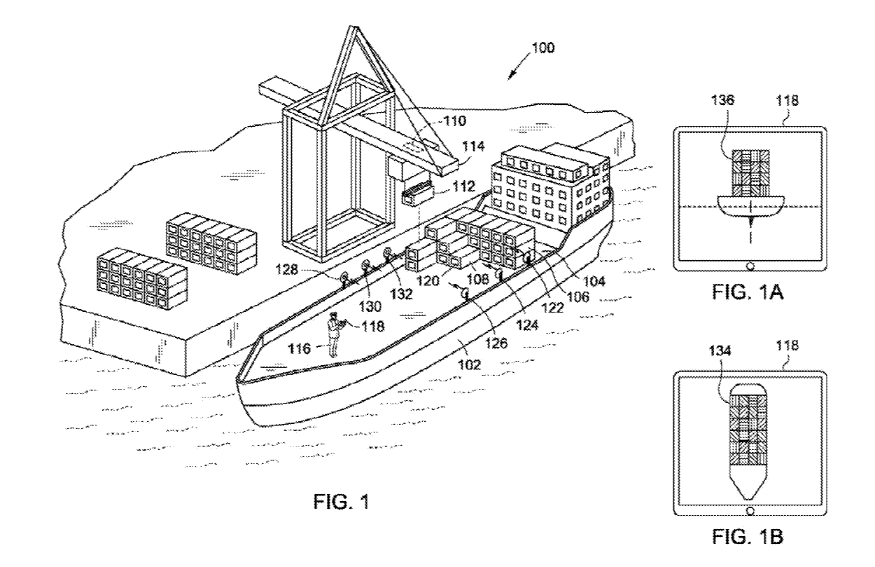

FIG. 1 depicts a diagram of a preferred embodiment of a system 100 that can be implemented to accurately assess the stability of a vessel 102. The system 100 comprises a first sensor 110, coupled with a crane 114, operative to determine the weight of a typical cargo 112. In another preferred embodiment, the first sensor can be attached to the cargo 11. The system 100 further comprises a data storage device, such as the data storage device 120, which is coupled with the cargo 112. The data storage device 120 receives the signal containing the weight of the cargo 112 from the first sensor 110 and stores it. The data storage device 120 also has an identification number which identifies the cargo to which it is attached. As such, the identity number and weight of the cargo 112 is stored within the data storage device 120. The system 100 further comprises a locator, which may comprise at least one of a RFID reader, a transmitter, a receiver, and a GPS system, such as those shown in FIG. 1 as elements 122, 124, 126, 128, 130, and 132. The locator is coupled with the vessel 102 and operates to retrieve the identity data of the data storage device 120 and the stored weight of the cargo 112 from the data storage device 120. The locator also determines a position, such as the x, y, z coordinates, of the cargo 112 relative to the cargo area 104 of the vessel 102. The system 100 further comprises a display device 118 which operates to display the cargo area 104, the weight of the cargo 112, and the x, y, z position of the cargo 112 relative to the cargo area 104.

In one embodiment, the first sensor 110 includes a load cell which creates an electrical signal whose magnitude is directly proportional to the weight of the cargo 112. In one instance, the first sensor 110 includes a hydraulic load cell. In another instance, the sensor 110 includes a pneumatic load cell. In yet another instance, the first sensor 110 includes a strain gauge load cell. The first sensor 110 further includes communication means, such as a RF transmitter, to transmit the weight of the cargo 112 to the data storage device 120.

In one embodiment, the data storage device 120 is a RFID tag. In one instance, the data storage device 120 is a passive RFID tag. In another instance, the data storage device 120 is an active RFID tag. In yet another instance, the data storage device 120 is a battery-assisted passive RFID tag. In one embodiment, the data storage device 120 is a read/write RFID tag where the weight of the cargo 112, obtained from and transmitted by the first sensor 110, is written into the data storage device 120. Field programmable tags may be write-once, read-multiple or blank tags which may be written with an electronic product code by the user such as the operator of the crane 114. As such, the data storage device 120 contains both its identity number and weight of the cargo 120 to which it is attached. As discussed above, the data storage device 120 being of the RFID tag type includes integrated circuit for storing and processing information, modulating and demodulating a radio-frequency (RF) signal, collecting DC power from the incident reader signal, and other specialized functions, and an antenna for receiving and transmitting the signal. The tag information is stored in a non-volatile memory. The RFID tag includes either fixed or programmable logic for processing the transmission and sensor data, respectively.

In one embodiment the locator includes an RFID reader which transmits an encoded radio signal to interrogate the data storage device 120. The data storage device 120 being of the RFID tag type receives the message and then responds with the identification and weight of the cargo 112. In one instance, the locator includes an active reader which may be one or more of the 122, 124, 126, and the data storage device 120 being of the active tag type which are awoken with an interrogator signal from the active reader 122, 124, 126.

In one embodiment, the locator which may comprise at least one of the elements 122, 124, 126, 128, 130, and 132, and the data storage device 120 is a real-time locating system (RTLS) which are used to automatically identify and track the location of the cargos, such as the cargo 112 in real time within the vessel 102.

In one instance, the cargo 112 relative to the vessel cargo area 104 is located by requiring identification signals from the data storage device 120 being of the tag type which is received by a multiplicity of readers in a sensory network which may be constructed by the 122, 124, 126, 128, 130, and 132, and a position is estimated using one or more locating algorithms, such as trilateration, multilateration, or triangulation. Equivalently, identification signals from several RTLS reference points can be received by the tag 120 and relayed back to a location processor included in the locator comprising one or more of the elements 122, 124, 126, 128, 130, and 132. Localization with multiple reference points requires that distances between reference points in the sensory network be known in order to precisely locate the tag 120 and the determination of distances is called ranging. Another way to calculate relative location is if the data storage devices such as the data storage device 120 are mobile tags which communicate directly with each other and then relay this information to a location processor included in the locator comprising one or more of the elements 122, 124, 126, 128, 130, and 132. The locator may alternatively use the GPS system determining the x, y, and z coordinates of the cargo 112.

In one embodiment, the display device 118 is a mobile display device with Bluetooth capability such as the iPad manufactured by the Apple Company. The display device may further include a user interface operative to display the cargo area 104 and the weight and position of the cargo 112 relative to the cargo area 104. In one instance, the user interface is an application software or an App which presents the weight distribution of the cargoes relative to the cargo area 104 to a vessel operator 116, such as the captain of the vessel.

FIG. 1A depicts a preferred embodiment for displaying the weight distribution of the cargos on the vessel 102 to assist the operator 116 in assessing the stability of the vessel 102. The cargoes, such as the cargo 112, are placed on the vessel 102 via the crane 114 and a vertical two dimensional surface 136 is shown including surface shading proportional to the weight distribution of the cargoes. In one instance, instead of surface shading, a color-coded vertical two dimensional surface is displayed on the display device 118 whose colors are proportional to the weight distribution of the cargoes.

FIG. 1B depicts a preferred embodiment for displaying the weight distribution of the cargos on the vessel 102 to assist the operator 116 in assessing the stability of the vessel 102. The cargoes, such as the cargo 112, are placed on the vessel 102 via the crane 114 and a horizontal two dimensional surface 134 is shown including surface shading proportional to the weight distribution of the cargoes. In one instance, instead of surface shading, a color-coded horizontal two dimensional surface is displayed on the display device 118 whose colors are proportional to the weight distribution of the cargoes. A similar two dimensional surface (not shown but known to artisans of ordinary skill) in the other remaining direction proportional to the weight distribution of the cargoes, either shaded or color-coded, can be displayed on the display device 118.

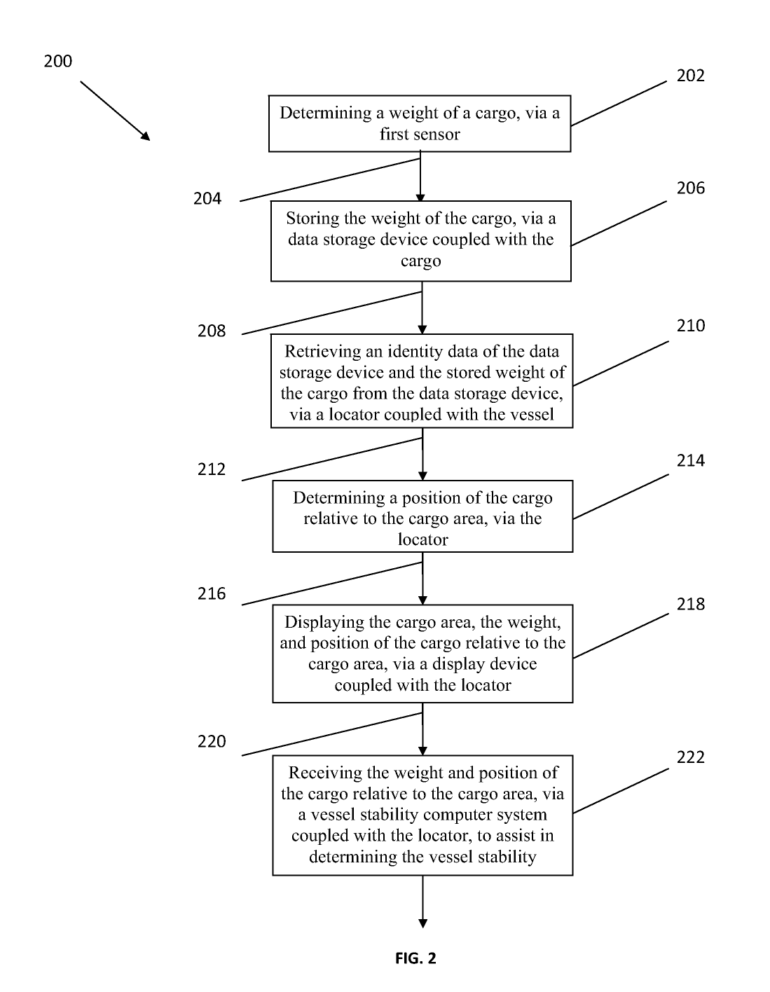

FIG. 2 is a flow diagram 200 of one preferred method of assessing vessel stability such as that depicted in FIG. 1. According to this embodiment, the method comprises determining a weight of a cargo, such as the cargo 112, via a first sensor, such as the first sensor 110 at 202. The method further comprises storing the weight of the cargo 112, via a data storage device, such as the data storage device 120 which is coupled with the cargo 112 at 206. The method further comprises retrieving an identity data, such as a serial number of the data storage device 120 and the stored weight of the cargo 112 from the data storage device 120, via a locator which may comprise at least one of a RFID reader, a transmitter, a receiver, and a GPS system, such as those shown in FIG. 1 as elements 122, 124, 126, 128, 130, and 132 at 210. The method further comprises determining a position of the cargo 112 relative to the cargo area 104, via the locator at 214. The method further comprises displaying the cargo area 104, the weight and position of the cargo 112 relative to the cargo area 104, via a display device, such as the display device 118 at 218. The method further comprises receiving the weight and position of the cargo 112 relative to the cargo area 104, via a vessel stability computer system (not shown but known to artisans of ordinary skill) coupled with the locator, to assist in determining the vessel stability at 222.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

1. A system for assessing vessel stability, said vessel comprising a cargo area operative to receive a plurality of cargoes, said system comprising:
(a) a first sensor operative to determine a weight of a cargo;
(b) a data storage device, coupled with the cargo, responsive to the first sensor and operative to store the weight of the cargo;
(c) a locator, coupled with the vessel, operative to retrieve an identity data of the data storage device and the stored weight of the cargo from the data storage device, and to determine an x, y, z coordinate position of the cargo relative to the cargo area; and
(d) a display device coupled with the locator and operative to display the cargo area and weight distribution of the cargoes as a two dimensional surface relative to the cargo area for visually assessing vessel stability, wherein the two dimensional surface is one of a horizontal, a vertical, and a transverse planes of the x, y, z coordinate system.

2. The system of claim 1, wherein the first sensor is a load cell.

3. The system of claim 1, wherein the data storage device is an RFID tag.

4. The system of claim 1, wherein the locator comprises at least one of an RFID reader, a transmitter, a receiver, and a GPS system.

5. The system of claim 1, wherein the display device comprises a user interface operative to display the cargo area and weight distribution of the cargoes as a two dimensional surface relative to the cargo area for visually assessing vessel stability, wherein the two dimensional surface is one of a horizontal, a vertical, and a transverse planes of the x, y, z coordinate system.

6. The system of claim 1, wherein the display device is a PDA.

7. The system of claim 1, wherein the vessel further comprises a vessel stability computer system coupled with the locator and operative to receive the weight and the x, y, z coordinate position of the cargo relative to the cargo area to assist in determining the vessel stability.

8. The system of claim 1, wherein the vessel is a cargo vessel.

9. A system for assessing vessel stability, said vessel comprising a cargo area operative to receive a plurality of cargoes, said system comprising:
(a) a first sensor operative to determine a weight of a cargo;
(b) a real-time locating system (RTLS), coupled with the vessel, said RTLS comprises an RFID tag, coupled with the cargo, said RFID tag is responsive to the first sensor and operative to store the weight of the cargo, wherein said RTLS is configured to retrieve an identity data and the stored weight of the cargo from of the RFID tag, to determine an x, y, z coordinate position of the cargo relative to the cargo area, and to display the cargo area and weight distribution of the cargoes as a two dimensional surface relative to the cargo area for visually assessing vessel stability, wherein the two dimensional surface is one of a horizontal, a vertical, and a transverse planes of the x, y, z coordinate system.

10. The system of claim 9, wherein the vessel further comprises a vessel stability computer system coupled with the RTLS and operative to receive the weight and the x, y, z coordinate position of the cargo relative to the cargo area to assist in determining the vessel stability.

11. A method for assessing vessel stability, said vessel comprising a cargo area operative to receive a plurality of cargoes, said method comprising:
(a) determining a weight of a cargo, via a first sensor;
(b) storing the weight of the cargo, via a data storage device coupled with the cargo;
(c) retrieving an identity data of the data storage device and the stored weight of the cargo from the data storage device, via a locator coupled with the vessel;
(d) determining an x, v, z coordinate position of the cargo relative to the cargo area, via the locator; and
(e) displaying the cargo area and weight distribution of the cargoes as a two dimensional surface relative to the cargo area for visually assessing vessel stability, wherein the two dimensional surface is one of a horizontal, a vertical, and a transverse planes of the x, y, z coordinate system, via a display de′ coupled with the locator.

12. The method of claim 11, further comprising:
(f) receiving the weight and the x, y, z coordinate position of the cargo relative to the cargo area, via a vessel stability computer system coupled with the locator, to assist in determining the vessel stability.

13. A method for providing a user interface for assessing vessel stability, the user interface being accessible via the display device, said method comprising a method as in claim 11.

14. A non-transitory machine-readable storage medium, which provides instructions that, when executed by a processing system, causes the processing system to perform vessel stability assessment operations according to a method as in claim 13.

15. The method of claim 11, wherein the first sensor is a load cell.

16. The method of claim 11, wherein the data storage device is an RFID tag.

17. The method of claim 11, wherein the locator comprises at least one of an RFID reader, a transmitter, a receiver, and a GPS system.

18. The method of claim 11, wherein the display device is a PDA.

19. The method of claim 11, wherein the vessel is a cargo vessel.

20. The method of claim 11, wherein the steps (b), (c), and (d) are performed via a real-time locating system (RTLS).
